(19) United States
(12) Patent Application Publication
(10) Pub. No.: US 2006/0161786 A1
(43) Pub. Date: Jul. 20, 2006

(54) Data and system security with failwords

(76) Inventor: Shrisha Rao, Cedar Rapids, IA (US)

Correspondence Address: SHRISHA RAO;23 RAMARAO LAYOUT, KATRIGUPPE, BANASHANKARI STAGE 3, BANGALORE, 560 085, IN

(21) Appl. No.: 11/039,577

(22) Filed: Jan. 20, 2005

(51) Int. Cl. H04L 9/00

(52) U.S. Cl. 713/183

(57) ABSTRACT

A method of computer system security is proposed that uses a failword, which is a password-like string that fools the malicious user, and does not alert him that he is not gaining proper access. A failword is indistinguishable to the malicious user from a password in its apparent functionality, but has a different real utility. Failword security is implemented by picking a set of failwords, by separating the system data into two sets: the open data set which is not protected, and the closed data set which is, by creating a decoy data set that imitates the closed data set, and by suitably updating these sets. The effect of this method is to give the system a strong counter-offensive capability against malicious users, especially useful where significant commercial or national security interests are involved.

### CROSS-REFERENCE TO RELATED APPLICATIONS

Not Applicable

### FEDERALLY SPONSORED RESEARCH

Not Applicable

### 1. BACKGROUND

1.1 Field of the Invention

The invention is related to the field of system security, and in particular, to password-based security and access control, addressing a fundamental weakness of the common password-access scheme.

1.2 Statement of the Problem (Discussion of Prior Art)

One of the most common and familiar means of security in online systems as well as in real life is by use of password information. A user or agent requesting access to a restricted resource is required to provide a password, and anyone able to provide the right password is considered to be authorized to access the resource. (See FIG. 1.)

Multiple layers of security can be built using several, mutually independent systems of password verification, so that a user must authenticate repeatedly in order to access, or to have continued access to, the protected resource. Layered security structures can also involve specific action by a controlling agency to ensure levels of accessibility of stored information to different users (e.g., on a need-to-know basis or permission to access being granted by personal choice or monitoring by higher authority). In such cases, only designated areas or functions of the system are accessible even with the available password authorization.

Current security protocols however do nothing with erroneous data offered as a password except deny access to the resource. Furthermore, a failed attempt has the effect of showing the user that the password is different from what was tried, and may enable an intruder to refine his approach. Normal built-in defenses against brute-force or other approaches by fast trials of alternatives for “breaking” the passwords also carry no counter-offensive response.

Common authentication protocols using passwords include the Password Authentication Protocol (PAP) and the Challenge-Handshake Authentication Protocol (CHAP) used on networks. PAP performs authentication using a two-way handshake between the parties. The password information is transmitted (if necessary) in cleartext, and hence is subject to eavesdropping and playback. CHAP allows verification of the remote party's identity periodically using a three-way handshake. The host sends the remote party a “challenge” message, to which the response is given using a value calculated via a one-way function. The host checks the response using its own calculation of the expected response; if there is no match, the connection is terminated.

Other inventions in the field, such as “Password Delay” (U.S. Pat. No. 6,360,326), “Computer Access via a Single-Use Password” (U.S. Pat. No. 6,370,649), “Limited-Life Machine-Specific Passwords” (U.S. Pat. No. 6,601,175), and “Authentication Based on Intersection of Password Sets” (U.S. Pat. No. 6,128,742) offer specific ingenious improvements to and means by which password access may be enforced. However, they do not state or anticipate the present work, which is a strict extension (see Remark 3 and FIG. 2) of the very idea of password-based access.

1.3 Objects and Advantages

The present discussion is largely orthogonal to the concerns in existing authentication protocols, and provides an ability to counteract the loss caused by unauthorized system or data access by a malicious user. The invention described here can be used to enhance existing systems and protocols. The discussion that follows is not specific to a certain type of password or protocol, and could be used to enhance security in any type of system that uses passwords to grant access to users. Although in our discussion we treat passwords and failwords as strings from an alphabet, the ideas could be easily applied to any password-like authentication protocol including biometrics and the like. It can also be applied in case of credit-card numbers and other protected data or transactions.

In computer systems where inappropriate access can compromise corporate or national security, it is not necessarily simply enough to employ strictly defensive password mechanisms that merely restrict access but are potentially subject to compromise; it is better to employ the method described herein, where a malicious user is at a distinct disadvantage and liable to be seriously misled, and where attempts at malice can thus be turned to advantage.

Depending on the level or type of security necessary, the present system can be used in conjunction with other security mechanisms, and is superior in many respects to existing ideas in use.

### 2 SUMMARY OF THE SOLUTION

A method is proposed by which a system can increase security against attempts at intrusion and unauthorized access. This is by use of a failword. A failword is similar to a password in appearance and should not alert the would-be intruder. However, its use should alert the system that an attempt at unauthorized access is underway, and it may also facilitate tracking the intruder. (For instance, a malicious user who obtains decoy data-explained below-using a failword can be tracked even later by the attempted use of such data.) A failword can be designed to mimic the behavior of a password (by giving the appearance of apparent access to the restricted data or resource), and also can be made easier to come by through unauthorized means.

A system that uses a failword is strictly different from a password system because such a system not only checks to see if a password has been supplied, but also, if the supplied string is not a password, it checks to see if it is a failword. (See FIG. 2, and compare with FIG. 1.).

To implement this type of security, data on the system is divided into two sets: one which is protected by a password, and one that which is not. The use of a password gives a user access to both sets. When a failword is used, the unprotected data is made available, as also is a set of decoy data that is meant to look to the malicious user like the protected data but does not have its functionality. Schematically, the user is taken to a distinguished failure state other than simple access error.

The purposes of using failword authentication can include giving false information to unauthorized users, and forcing malicious users to reveal themselves for prosecution or such actions.

The ideas described can be used at a system-wide level, or else may be applied within a system where access is to be restricted to data or some other resource. Without loss of generality, in the discussion that follows, a user is any human or agent that seeks access to a restricted resource using passwords, and a system is the infrastructure (possibly including system administrators and the like) that grants such access.

### 3 DESCRIPTION OF DRAWINGS

FIG. 1 is a flow-chart schematic illustrating basic password access.

FIG. 2 is a similar flow-chart schematic illustrating failword access, and shows how this is different from basic password authentication, by offering a distinguished fail state that is different from failure to authenticate.

FIG. 3 shows the division of system data into open, closed, and decoy data sets. (A user has access to the open data set and the closed data set upon use of a password, and to the open data set and the decoy data set upon use of a failword.)

FIG. 4 shows the appearance of the system to a user who supplies either a password or a failword.

FIG. 5 shows an extension of the concept suggested by FIG. 3, with multiple decoy data sets, bound to at least N failwords, where N>1.

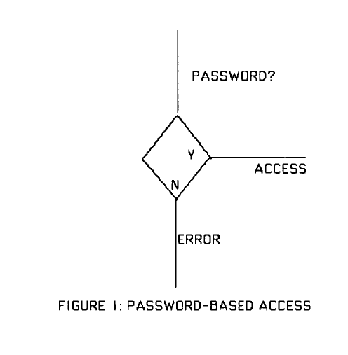

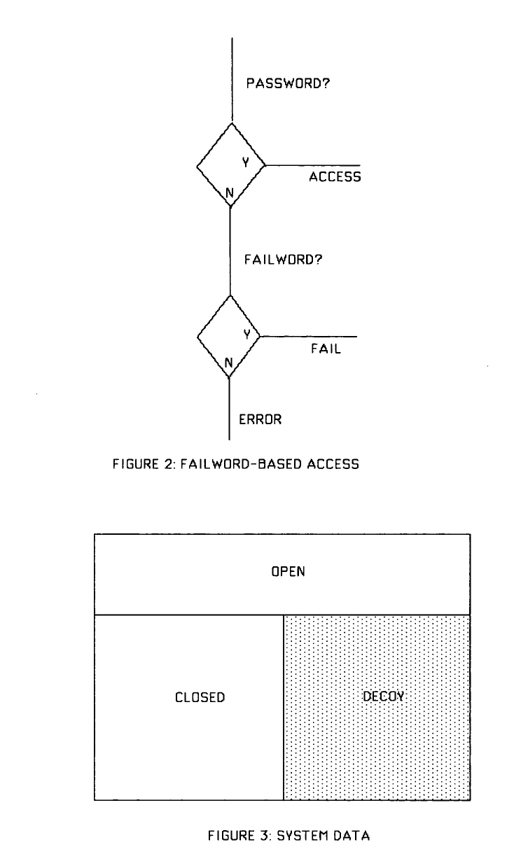

### 4 DETAILED DESCRIPTION

4.1 Basic Theory

Let Σ be some suitable alphabet from which passwords and failwords are chosen. A string is a finite-length sequence of characters from Σ. Following convention, Σ* is the set of all finite-length strings from Σ. Let P be a set of passwords, and F be a set of failwords, with the restriction that P∩F=Ø (i.e., no string is both a password and a failword). We need two functions app and util, respectively called the “appearance” and “utility” functions, with the following mathematical properties.
app, util: Σ*→R Definition 1

Intuitively, the app and util functions set the apparent and actual value of any candidate string (password or failword), with the apparent value being the value expected by the user, and the actual value being the value delivered by the system to the user.

Furthermore, the following properties are taken to hold in respect of these two functions.
∀p∈P, ∀f∈F: Definition 2
(1) app(p)=util(p)=app(f).
(2) util(p)≠util(f).

Intuitively, there is a function app that determines the appearance or apparent value of the candidate phrase (password or failword), and a function util that determines its actual value.

The app function should return the same value for both password and failword, thus making it impossible for an intruder to use the function to check the correctness of a candidate string.

The util function should, however, fix the actual value of the candidate, with the failword having a different return value than the password.

The two conditions (1) and (2) jointly ensure that the user does not perceive that what he used was a failword rather than a password.

A failword may be a distinct phrase (or member of a set of them), rather than being just any phrase that is not a password. In other words, we allow for there to be strings that are neither passwords nor failwords.

Remark 3 Normal password implementations with no failwords are equivalent to the case where app=util and F=Σ*−P.

The apparent value is the same as the actual utility, the intruder is immediately alerted to the correctness—or lack thereof—of the attempted password, and every string that is not a password is a failword.

Therefore, we see that a system that uses failwords is strictly larger in scope (i.e., is more general) than a common password-authentication system without them.

Remark 4 For a failword system to be meaningful, ∀f]∈F, app(f)>util(f).

The apparent value of a failword as shown to the user must always exceed its actual utility. This is already delicately implied by the conditions of Definition 2, but it is worth pointing out separately. A malicious user is not likely to use a failword if its apparent value is not greater than its utility.

4.2 Implementing Failwords

4.2.1 Data Sets

To design a system to use failwords, it is necessary to divide the data on the system into two parts or types: that which is protected from unauthorized access, and that which is not. Some data, especially that relating to the appearance or access response of the system, or that which is available from other sources, is not protected. This is to maintain a suitable appearance, and also to facilitate ease of updates (see Remark 7.)

Similarly, same data such as names of commonly-found files, or users known to have access to the system, need not be protected. The set of data that is made available is called the open data set, and the set of data that is protected is called the closed data set.

Corresponding to the closed data set, a set of ersatz data called a decoy data set is created. While a user who obtains access through a password has access to the closed data set as well as to the open data set, an unauthorized user who uses a failword obtains access to the open data set and the decoy data set. (See FIG. 3.)

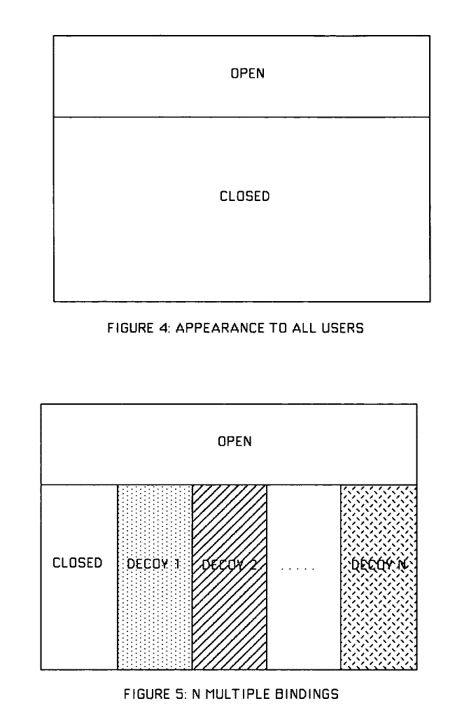

However, the appearance of the system to both kinds of users is the same (FIG. 4).

Remark 5 A normal password-authenticated user should not have access to the decoy data set.

This follows as a consequence of the need for the system appearance to be alike with both password and failword.

4.2.2 Multiple Bindings

It is possible to extend the method described above with multiple failwords and multiple decoy sets. There can be one decoy set for each failword, or several failwords can be bound to one decoy set, or some combination of both. FIG. 5 shows a schematic of such multiple binding of some size N>1. In this instance, the number of failwords can be arbitrarily large, but it cannot be any less than N.

4.2.3 Updates

The system updates the open and closed data sets by moving pieces of data from the closed data set to the open data set when it is no longer considered necessary to protect them, and removing the corresponding pieces of data in the decoy data set. Such moving of data from the closed data set to the open data set may be age-driven (e.g., data that is older than its useful age can be in the open data set), or it may be event-driven.

In case of age-driven updates, it is necessary for pieces of data in the closed data set to have a time of expiry (defined as an absolute time, or as an age since creation or modification, as appropriate) associated with them, denoting the period of their presumed usefulness. The system should perform the update by moving time-expired pieces of data from the closed data set to the open data set.

In case of event-driven updates, pieces of data are moved from the closed data set to the open data set upon specific command. Depending on the detailed design of the system, such a command may be issued by a human (or agent acting for a human), or it may be issued by a different part of the system based on events external to the system.

Remark 6 Updates to the data sets should be carried out in such a way that the union of the open data set and the decoy data set remains consistent.

This is necessary to avoid giving notice to the malicious user that he is using a failword; inconsistent updates would have the effect of making it immediately obvious that a failword is in use.

Remark 7 Consistent updates are most difficult if the open data set is small, and get easier as it gets larger.

4.3 Modes of Operation

The following is a list of some of the ways in which failword access can be applied to enhance system and data security.

4.3.1 Best Mode—Preventing Replays

Consider a system that expires passwords with age or use, and converts each expired password into a failword. A malicious user who sniffs and records passwords for future use, or who uses replays to break session authentication protocols, will end up using failwords instead of passwords.

4.3.2 Secondary Mode—String Distance

For another possible use of failwords, consider the “string distance” between two strings of characters, defined on the basis of any mathematical function which identifies the similarity—or lack thereof—of two strings. The string distance between two very similar strings would be considered low, and the string distance between two dissimilar strings would be considered high. A common, though not unique, function that could be used to measure string distance is simply a count of the number of characters in which two strings differ.

4.3.2.1 Low String Distance

A secondary mode of application is one where the failword has a low string distance as compared to a legitimate password. This removes any possibility that an attacker can successively refine towards a password. However, it also means that slight errors in authentication have serious consequences.

4.3.2.2 High String Distance

This is similar to the previous case, but here, any string with a large string distance from a password is regarded as a failword. In this case, there is not a large penalty for a slight miss, but a user who is clearly nowhere near the mark is penalized, on the assumption that such a user is clearly malicious.

4.3.3 Secondary Mode—Poison Pill

In systems that are expected to be subjected to attempts at unauthorized access, a failword can deliberately be made easy to find, or easier to find, than the password. For instance, many systems are subject to attacks where a malicious user (e.g., an employee about to leave an employer) obtains access to an encrypted password file, and then decrypts it at leisure to obtain password access. In such cases, failwords can be made available to the malicious user as poison pills.

4.3.4 Secondary Mode—One Among Many

A system can offer a malicious user a large set of candidate passwords, with all but one being failwords, making it impossible for the malicious user to pick the right one easily.

4.3.5 Secondary Mod—-Credit Card Authentication

A credit card authentication system can use failwords (e.g., compromised credit card numbers) to track attempts at fraud.

### 5. CONCLUSION, RAMIFICATIONS, AND SCOPE OF INVENTION

Thus, it may be seen that use of failwords in system security provides not only the passive advantages commonly obtained with password-based security, but also gives an active advantage against the malicious user, who now has a strong incentive not to attempt to gain unauthorized access.

Those skilled in the art can create variations of the above-described modes of use that fall within the scope of this invention. As such, the invention is not limited to these specific examples, but only by the following claims and their equivalents such as there may be.

What is claimed is:

1. A method for protecting computer systems, comprising the steps of:
Storing a first set of data that is secured by a password and constitutes access, and a second set of data that is linked to a failword and constitutes a special failure state for unauthorized users;
with said first set comprising a subset of system data that contains secret information, and a second set comprising data with no secret information;
providing the second set of data in such a way as to imitate the appearance of the first set, but without conveying the information contained in the first set;
providing a user with access to the second set of data in a manner presenting complete consistency and apparent authenticity to a user, when the failword is presented to the system.

2. The method of claim 1, wherein every password, once used, is designated as a failword.

3. The method of claim 1, wherein any string at a low string distance from a password is designated a failword.

4. The method of claim 1, wherein any string at a high string distance from a password is designated a failword.

5. The method of claim 1, wherein failwords are deliberately made easier for a malicious user to find.

6. The method of claim 1, wherein a large set of all candidate passwords (comprising both password and failwords) is known or knowable, but the password cannot be picked from them with certainty by an unauthorized user.

7. The method of making a system to use failwords, comprising the steps of:
Analyzing the data to be protected, with the data being grouped into two parts, one part, an open data set comprising data that can be made available to a malicious user, and the other, a closed data set, of data that cannot be made available to a malicious user;
creating a decoy data-set that is designed to emulate many of the appearance or other characteristics of the closed data set but without its functionality;
picking a set of failwords, any member of that set being a pre-determined string that gives access to the decoy data set.

8. The method of claim 7, wherein an authenticated user who supplies a password does not have access to the decoy data set.

9. The method of claim 7, wherein certain pieces of data on a system, especially as relates to its expected response to a correct password, or data on it that is presumed to be known or knowable, belong to the open data set.

10. The method of claim 7, wherein there can be multiple decoy data sets, with bindings to multiple failwords, with the constraint being that each failword must be bound to a single decoy set, but that multiple failwords can be bound to a single data set.

11. The method of claim 7, wherein a system maintains a time of expiry for pieces of data in the open data set, and moves time-expired data from the closed data set to the open data set.

12. The method of claim 7, wherein a system moves pieces of data in the closed data set to the open data set upon specific command.

13. The method of claim 7, wherein the decoy data set is updated every time the open data set is.

14. The method of claim 7, wherein any data set is updated only in such manner that the union of the open data set and the decoy data set remains consistent over updates.

15. A method for securing data, comprising the steps of:
storing data in a first set of data and a second set of data;
said first set of data is data which has associated therewith a first predetermined level of desired access restriction;
said second set of data is data which has associated therewith a second predetermined level of desired access restriction;
said first predetermined level of desired access restriction being of a level which provides higher security and more access difficulty than said second predetermined level of desired access restriction;
monitoring input from a user to determine if said user has provided a predetermined password which permits access to said said first set of data;
if said input is said predetermined password, then providing said user with access to said first set of data;
if said input is not said predetermined password then refraining from providing said user with said first set of data;
if said input is a predetermined failword then providing said user with said second set of data;
wherein said second set of data has been predetermined to provide an appearance of said first set of data so that said user mistakes said second set of data for said first set of data; and
said failword is predetermined to be a charter string which meets predetermined criteria which include predetermined inditia of not being an typographical erred version of said password.
